(19) United States
(12) Patent Application Publication
(10) Pub. No.: US 2023/0261489 A1
(43) Pub. Date: Aug. 17, 2023

(54) MOUNT FOR GANG BOX CHARGER

(71) Applicant: MILWAUKEE ELECTRIC TOOL CORPORATION, Brookfield, WI (US)

(72) Inventors: Brijeshkumar K. Meghpara, Germantown, WI (US); Marc S. D'Antuono, Whitefish Bay, WI (US); Harold A. Morrow, JR., Waukesha, WI (US); Keith G. Koch, Kenosha, WI (US); Jacob D. Rosenthal, Brookfield, WI (US)

(21) Appl. No.: 18/168,460

(22) Filed: Feb. 13, 2023

Related U.S. Application Data
(60) Provisional application No. 63/309,684, filed on Feb. 14, 2022.

(51) Int. Cl. H02J 7/00

(52) U.S. Cl. CPC H02J 7/0045; H02J 7/0042

(57) ABSTRACT

A charging station includes a hub configured to house electronics for controlling the charging station, a first wing extending from the hub in a first direction, a second wing extending from the hub in a second direction opposite the first direction, a first charging port disposed on one or more of the first wing and the second wing, the first charging port including a first battery receptacle configured to receive and charge a battery pack of a first type, a second charging port disposed on the hub, the second charging port including a second battery receptacle configured to receive and charge a battery pack of a second type different than the first type, and a mount assembly coupled to one or more of the hub, the first wing, and the second wing. The mount assembly is configured to selectively mount the charging station on a structure.

### CROSS-REFERENCE TO RELATED APPLICATIONS

This application claims priority to U.S. Provisional Pat. Application No. 63/309,684, filed Feb. 14, 2022, the entire contents of which are incorporated by reference herein.

### FIELD

The present disclosure relates to charging devices and systems. More particularly, the present disclosure relates to the mounting of power tool charging devices and systems in a gang box, a job box, or other storage containers.

### BACKGROUND

Generally, gang boxes, job boxes, and other similar storage containers are used at job sites. Such boxes/containers are used to retain tools, power tools, and batteries for power tools.

### SUMMARY

One embodiment of the present disclosure provides a charging station removably mountable on a structure, the charging station including a housing defining a first side and a second side opposite the first side; a plurality of charging ports disposed on the first side, each of the plurality of charging ports including a battery receptacle configured to receive and charge a battery pack; and a mount assembly disposed on the second side and engageable with the structure to removably mount the charging station thereon, the mount assembly including a first mount interface and second mount interface, the second mount interface being different than the first mount interface.

Another embodiment of the present disclosure provides a charging removably mountable on a structure including a container, the charging station including a charging portion; a mounting portion; a first charging port disposed on the charging portion, the first charging port including a first battery receptacle configured to receive and charge a battery pack of a first type; a second charging port disposed on the charging portion, the second charging port including a second battery receptacle configured to receive and charge a battery pack of a second type different than the first type; and a mount assembly coupled to the mounting portion and selectively couplable with the container.

Yet another embodiment of the present disclosure provides a charging station including a hub configured to house electronics for controlling the charging station; a first wing extending from the hub in a first direction; a second wing extending from the hub in a second direction opposite the first direction; a first charging port disposed on one or more of the first wing and the second wing, the first charging port including a first battery receptacle configured to receive and charge a battery pack of a first type; a second charging port disposed on the hub, the second charging port including a second battery receptacle configured to receive and charge a battery pack of a second type different than the first type; and a mount assembly coupled to one or more of the hub, the first wing, and the second wing, wherein the mount assembly is configured to selectively mount the charging station on a structure.

Features and aspects of the disclosure will become apparent by consideration of the following detailed description and accompanying drawings.

### BRIEF DESCRIPTION OF THE DRAWINGS

FIG. 1 is a perspective view of a charging station for a gang box, according to one embodiment.

FIGS. 2A - 2C are perspective views of the charging station mounted to the gang box in some example ways.

FIG. 3 is a rear perspective view of the charging station, illustrating a mounting portion of the charging station.

FIG. 4 is a cross-sectional view of the charging station, taken through section 4—4 of FIG. 3.

FIG. 5 is a side view of the charging station, illustrating a mounting cleat member.

FIG. 6 is a side view of the charging station, illustrating an alternate mounting cleat member.

FIG. 7A is a side view of the charging station, illustrating an adjustable mounting member in one position.

FIG. 7B is a side view of the charging station of FIG. 7A, illustrating the adjustable mounting member in another position.

FIG. 7C is a top view of the charging station of FIG. 7A.

FIG. 8 is a side view of the charging station, illustrating a removable mounting member.

FIG. 9 is a side view of the charging station of FIG. 8, illustrating another removable mounting member.

FIG. 10 is a perspective view of the charging station, illustrating one application of the removable mounting member of FIGS. 8 or 9.

FIG. 11 is an isolated perspective view of the removable mounting member of FIG. 9.

FIG. 11A is a side view of the charging station and removable mounting member of FIG. 9, illustrating an additional retention member.

FIG. 11B is a side view of the charging station and removable mounting member of FIG. 9, illustrating another additional retention member.

FIG. 12 is a perspective view of the charging station, illustrating a removable mounting member.

FIG. 13 is a side view of the charging station of FIG. 12, illustrating the removable mounting member attached in one manner.

FIG. 14 is a side view of the charging station of FIG. 13, illustrating the removable mounting member attached in another manner.

FIG. 15 is a perspective view of a mounting panel attached to a portion of the gang box, illustrating a device coupled to the mounting panel.

FIG. 16 is another perspective view of the mounting panel of FIG. 15.

FIG. 17 is another perspective view of the mounting panel of FIG. 15, illustrating the charging station coupled to the mounting panel.

FIGS. 18A - 18C are perspective views of the charging station, illustrating example mounting hooks for the charging station.

FIG. 19 is a perspective view of a multi-bay charging station useable with the mounts of FIGS. 1-18.

Before any independent embodiments of the disclosure are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

### DETAILED DESCRIPTION

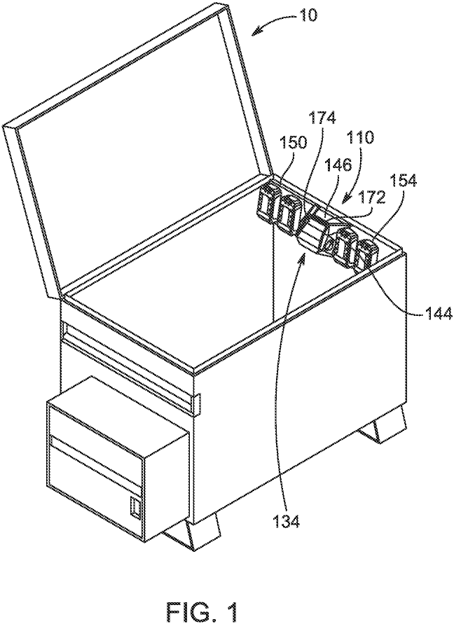

FIG. 1 illustrates a illustrates a charging station 110 according to one embodiment of the invention. The charging station 110 is configured to couple or attach to a structure, such as a gang box 10, job box, container, and/or the like, that may be on a construction site or other worksite (e.g., job site). Gang boxes typically hold tools and other equipment, such as power tools, that are necessary on the worksite. Power tools are operable to run off power provided by a battery or battery pack. During a workday, the battery packs deplete and need to be replaced with a fully charged battery pack. As such, the charging station 110 provides power to battery packs that are coupled to the charging station 110.

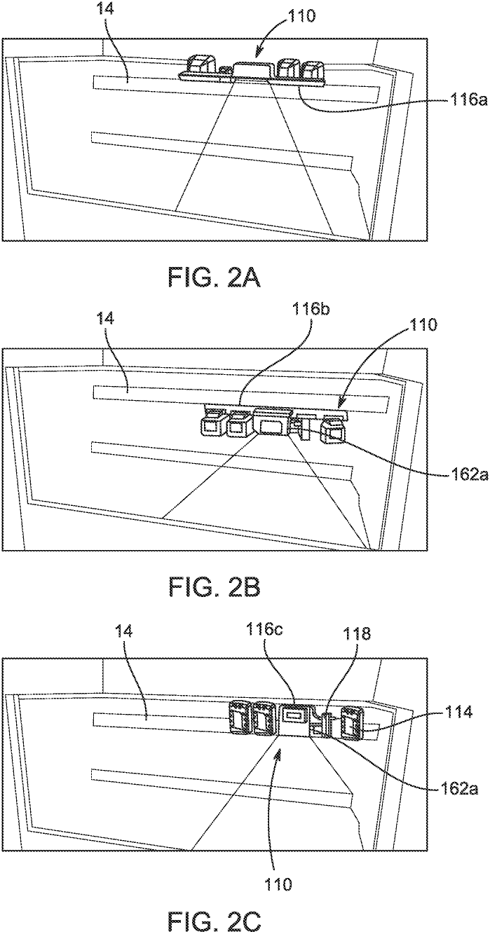

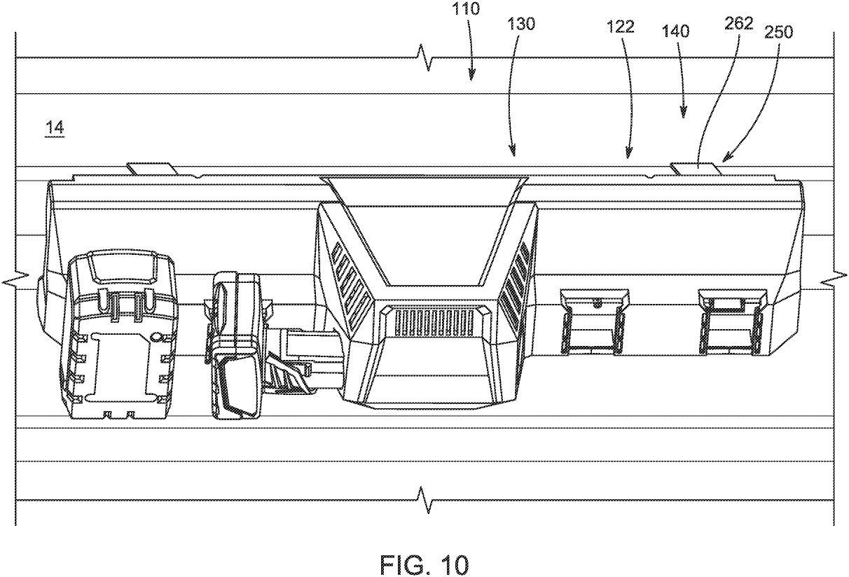

As illustrated in FIGS. 1 and 2A-2C, the charging station 110 may support and charge a first battery pack 114 or a second battery pack 118 that is different from the first battery pack 114. The battery packs 114, 118 may include any of several different nominal voltages (e.g., 12V, 18V, etc.), and may be configured having any number of different chemistries (e.g., lithium-ion, nickel-cadmium, etc.). The battery packs 114, 118 are removable coupled (e.g., inserted) to the charging station 110. In the illustrated embodiment, with brief specific reference to FIGS. 2C and 10, the first battery pack 114 may be of a first type, such as a slide-type battery pack, and the second battery pack 118 may be of a second type, such as a stem-type battery pack.

FIG. 2A illustrates the charging station 110 mounted to the gang box 10 in a first example manner, in which the charging station 110 is supported on a lower surface or portion 116a. FIG. 2B illustrates the charging station 110 mounted to the gang box 10 in a second example manner, in which the charging station 110 is supported on an upper surface or portion 116b. FIG. 2C illustrates the charging station 110 mounted to the gang box 10 in a third example manner, in which the charging station 110 is supported on a rear surface or portion 116b. As will be described in greater detail below, the charging station 110 includes mounting solutions or mount interfaces that allow the charging station 110 to be mounted, retained, etc. in the illustrated example manners, as well as others. The mount interfaces further allow for the charging station 110 to be portable and selectively/removably supported on various structures, surfaces, and/or the like, such as a wall or shelf of the gang box 10.

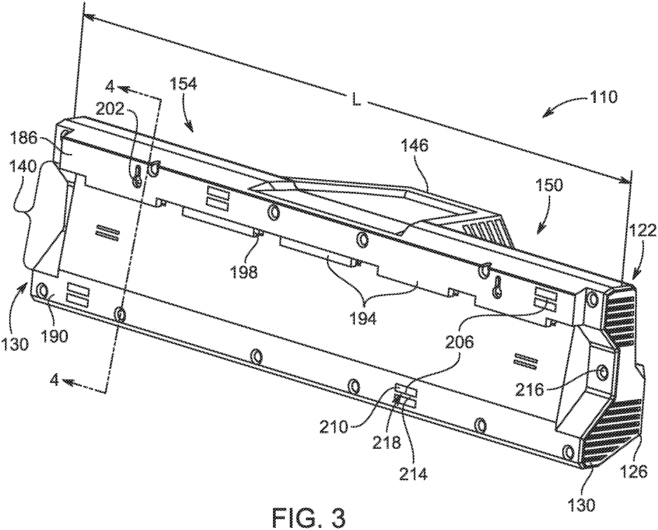

Referring now to FIG. 3, the charging station 110 includes a housing 122 that is formed of two clamshell pieces (e.g., a front housing 126 and a back housing 130). The housing 122 defines a forward side 134 (FIG. 1) and a rearward side 138 opposite the forward side 134. The front housing 126 may be referred to as the “charging portion” while the back housing 130 may be referred to as the “mounting portion.”

The housing 122 also defines a length L of the charging station 110. In some embodiments, the length L of the charging station 110 is approximately 24 inches for use with a gang box that is 48 inches. In some embodiments, the length L of the charging station 110 is approximately half the length of the gang box to which it is coupled. In other embodiments, the length L of the charging station 110 may be more than half the length or less than half the length of the gang box. As such, the gang box 10 may support a plurality of charging stations 110 along its length. As illustrated in FIG. 1, one embodiment of the charging station 110 is configured to be mounted on a side wall or the gang box 10. In such embodiment, the length L is less than a length of a side wall of the container. A power cord may extend from the charging station 110 to provide power to the charging station 110. The power cord may be connected to an outlet supported by the gang box 10 or a wall outlet.

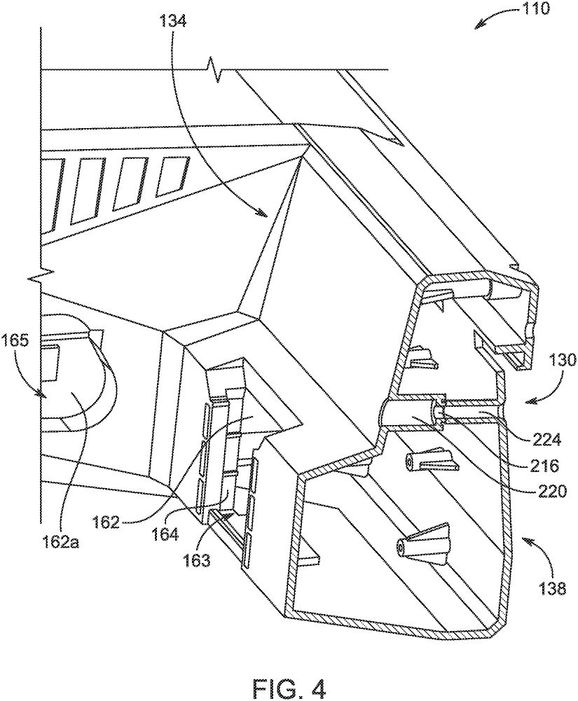

As illustrated in FIGS. 1 and 3, the housing 122 includes an electronics hub 146, a first wing 150 extending from one side of the electronics hub 146 (e.g., in a first direction), and a second wing 154 extending from the other side of the electronics hub 146 opposite the first wing 150 (e.g., in an opposite second direction). The electronics hub 146 includes control electronics for the charging station 110. The control electronics may include at least one controller or printed circuit board (PCB) that controls operation of the charging station 110. The charging station 110 includes a plurality of charging ports 162 (see also FIG. 4). In the illustrated embodiment, the first wing 150 includes two ports 162 and the second wing 154 includes two ports 162. In other embodiments, the first and second wings 150, 154 may include less than two ports 162 or more than two ports 162. For example, the first wing 150 may include one port 162 and the second wing 154 may include three or more ports 162.

Further, the charging station 110 may not include one of the wings such that a single wing includes multiple ports. Each of the ports 162 defines at least one receptacle that is configured to receive a battery pack. As shown in FIGS. 2B, 2C, 4, and 5, the electronics hub 146 includes another port 162a including a battery receptacle 170. The first battery receptacles 166 may be configured to receive the first battery pack 114 and the second battery receptacles 170 may be configured to receive the second battery pack 118. In the illustrated embodiment, the first battery packs 114 may be inserted into the first battery receptacles 166 in a direction that is transverse to (e.g., normal to, perpendicular to, offset from, etc.) a direction in which the second battery packs 118 may be inserted in the second battery receptacles 170. As particularly shown in FIG. 4, the first battery receptacle 166 may include a slot 163 rails 164 configured to receive a slide-type battery pack, and the second battery receptacle 162a may include a well or socket 165 configured to receive a stem-type battery pack. In some embodiments, the first and second battery packs 114, 118 may be inserted in a common or similar direction for charging on the charging station 110.

Each of the ports 162, 162a may include controller(s) to control the charging supplied to a battery pack 114, 118. In some embodiments, two of the ports 162, 162a charge simultaneously while two of the ports 162, 162a charge in sequential order. In other embodiments, all the ports 162, 162a may charge simultaneously or sequentially. As illustrated in FIG. 1, the electronics hub 146 may also include a plurality of USB ports 174 (e.g., USB-A, USB-C, etc.). A power switch 178 may also positioned on the electronics hub 146. Each of the ports 162, 162a may also include an indicator light.

Referring now to FIGS. 3-6, the mounting portion 130 includes a mount assembly 140 coupled to (e.g., formed with, connected to, etc.) the mourning portion 130. In some embodiments, the mount assembly 140 has a top rail 186 and a bottom rail 190 that collectively provide a mount interface. The top and bottom rails 186, 190 assist with attaching the charging station 110 to the gang box 10 or other structures. The top rail 186 may include a plurality of cleats 194 that define a lip 198. In other embodiments, the top rail 186 may include a single cleat extending across the entire top rail 186. Parts of the gang box 10, such as a shelf 14 (FIGS. 2A-2C) or wall, may be positioned within the lip 198 to assist in supporting the charging station 110 on a gang box 10. Embodiments of the mounting portion 130 for the charging station 110 may be configured to provide different mount interfaces (e.g., mounting solutions, methods, etc.) that allow the charging station 110 to be mounted, retained, etc.

With reference to FIG. 3, the top and bottom rails 186, 190 each include a plurality of magnet assemblies 206 that may form another mount interface different than the mount interface provided by, for example, the top rail 186 and the bottom rail 190. Specifically, the top rail 186 includes two magnet assemblies 206 (one adjacent each corner of the back housing 130) and the bottom rail 190 includes two magnet assemblies 206 (one adjacent each corner of the back housing 130). In other embodiments, the top and bottom rails may include more than two magnet assemblies 206 or less than two magnet assemblies 206. Each magnet assembly 206 includes at least one magnet 210 and at least one billet 214. The billets 214 are made of a ferromagnetic material, such as metal or the like. The magnets 210 produce a magnetic field within the billets 214. The billets 214 extend through openings 218 in the back housing 130 to couple the charging station 110 to a surface of the gang box 10, other mating surfaces, and/or one or more mating attachments that can be used to support the charging station 110.

As illustrated in FIGS. 3 and 4, the mounting portion 130 includes a plurality of mounting apertures 202 configured to receive fasteners to assist in supporting the charging station 110 from the gang box 10 or other structure. The mounting apertures 202 may be keyed to receive the head of a fastener that has been secured to a mounting surface or other attachment, thus providing another different mounting interface. In some embodiments, the keyed mounting apertures 202 may be provided on multiple parts of the charging station 110 and/or in different orientations. The keyed mounting apertures 202 may be covered by the charging station 110 once the charging station 110 is secured to the gang box 10 or other mounting surface/attachment.

Referring now to FIGS. 3 and 4, the mounting portion 130 includes a plurality of mounting through-holes 216 configured to receive fasteners to assist in supporting the charging station 110 from the gang box 10 or other structure, thus providing yet another different mounting interface. In the illustrated embodiment, the through-holes 216 extend through the housing 122 from the forward side 134 to the rearward side 138. Each of the through-holes 216 can receive a fastener or fastener assembly, such as a nut-bolt-washer assembly, to couple the charging station 110 to a mounting surface.

In one example, the through-holes 216 on the charging station 110 can be aligned with one or more holes (e.g., pilot holes, mounting holes, etc.) on a surface, and the fastener/fastener assembly can be inserted into the through-hole 216 to secure the charging station 110. In some instances, the magnet assembly 206 may be utilized to align the charging station 110 to a metallic surface. In the illustrated embodiments, the through-holes 216 each include a head recess 220 and a bore recess 224. The head recess 220 may be a clearance head configured to receive the head of a fastener, a nut, or a bolt head, such that an end of the fastener lies flush with the charging station 110. The illustrated charging station 110 includes two similarly sized through-holes 216, but multiple through-holes having similar or different sizes are contemplated.

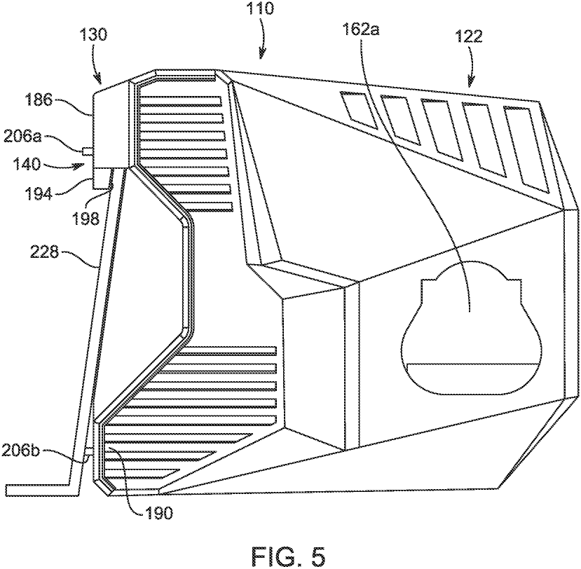

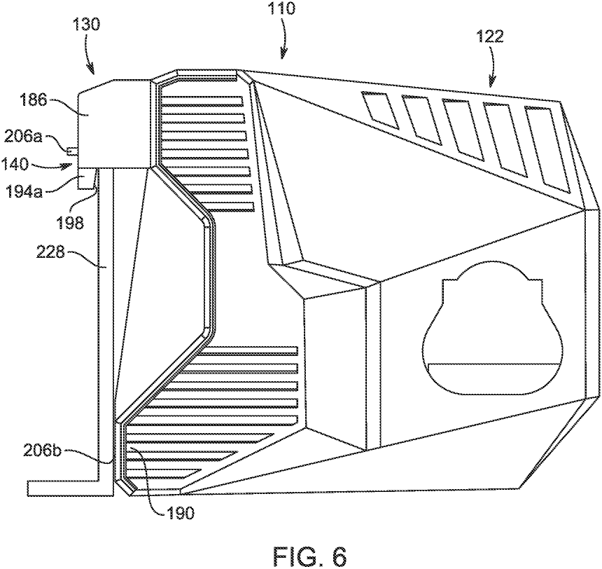

Referring now to FIGS. 5 and 6, the mounting portion 130 may be placed over a rim 228 (e.g., edge of shelf 14, bar, wall surface, side wall of gang box 10, etc.) or other mounting member, such as a flange or tab, to assist with attaching the charging station 110 to the gang box 10 or other structure via yet another different mounting interface. FIG. 5 illustrates the rim 228 positioned below the lip 198 of the cleats 194. FIG. 6 illustrates an alternate (e.g., larger/wider) rim 228 positioned below the lip 198 of alternate cleats 194a. The alternate cleats 194a extend from the top rail 186 by a greater amount than the cleats 194 such that the alternate cleats 194a can receive a larger structure. The alternate cleats 194a may increase an overall depth of the charging station 110 by approximately 17.00 mm. Stated another way, the charging station 110 having the alternate cleats 194a may result in a larger footprint of the charging station 110. In operation, the alternate cleats 194a may be utilized for structures (e.g., rim 228) that are too large for the cleats 194, the cleats 194 (e.g., smaller) may be utilized for additional stability on thinner structures (e.g., rim 228).

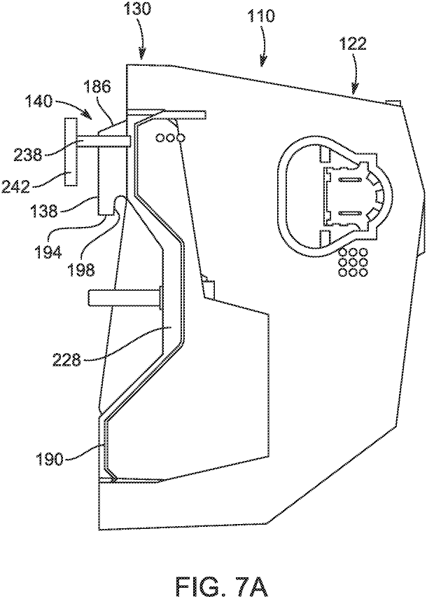

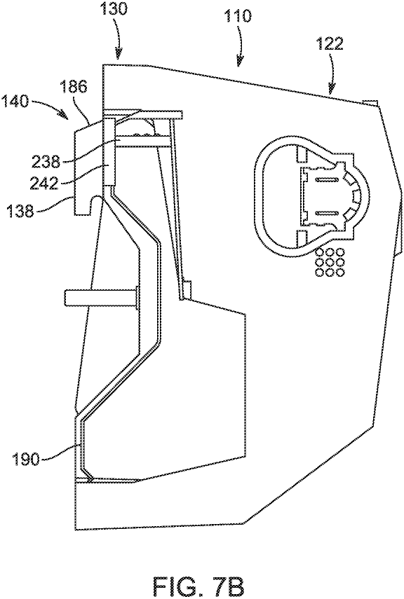

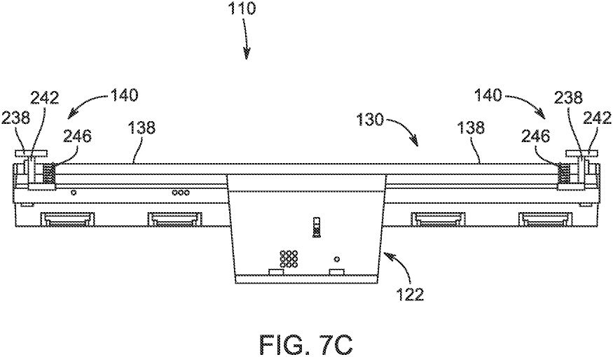

In some embodiments of the mounting portion 130, as illustrated in FIGS. 7A-7C, the mount assembly 140 of the charging station 110 may further or alternatively include adjustable clips 238 that allow a user to clip the charging station 110 onto the rim 228/shelf 14 (FIG. 5) or wall of the gang box 10. The adjustable clips 238 may be supported in the housing 122 and moveable between an extended position (FIGS. 7A and 7C) and a retracted position (FIG. 7B) to provide additional different mount interfaces. While in the extended position, the adjustable clips 238 may receive the rim 228 (FIGS. 5 and 6) between the rearward side 138 of the mounting portion 130 and a head 242 of the adjustable clip 238. In the retracted position, the adjustable clip 238 may be retracted inwardly, by a biasing member 246 (FIG. 7C), such that the head 242 of the adjustable clip 238 is flush an exterior of the housing 122.

In the illustrated embodiment, the mount assembly 140 includes two adjustable clips 238 having heads 242 positioned adjacent the top rail 186. A base portion of the adjustable clips 238 is secured within the housing 122 such that the heads 242 are rotated and/or flexed between the extended and retracted positions. In other embodiments, an orientation of the adjustable clips 238 may be flipped and/or tilted. In some embodiments, the heads 242 may have a hook shape and include a gripping surface and/or material. In some embodiments, the heads 242 may also include one or more of the magnet assemblies 206. In the illustrated embodiment, the adjustable clips 238 may obviate the need for the cleats 194, although a single charging station 110 may be provided with both the clips 238 and the cleats 194.

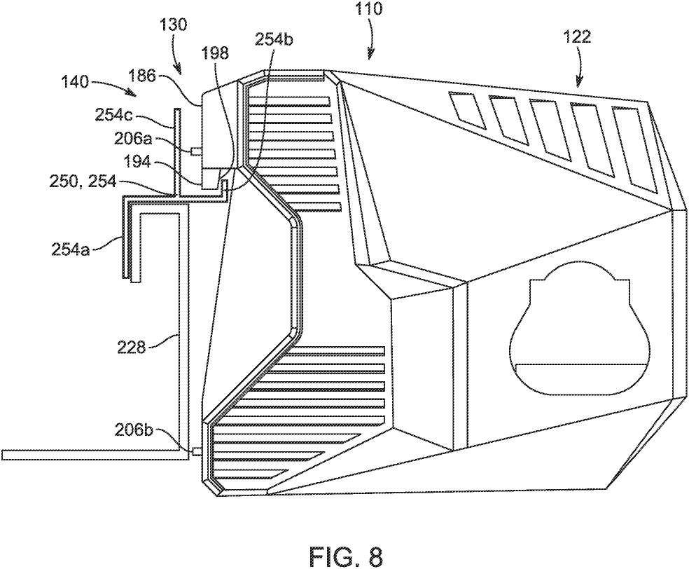

In some embodiments of the mounting portion 130, as illustrated in FIGS. 8-11, the mount assembly 140 of the charging station 110 may further or alternatively include removable hangers or clips 250 that allow a user to support the charging station 110 onto the rim 228/shelf 14 or wall of the gang box 10. The clips 250 may be detachable from the mounting portion 130, such as for storage and/or transport of the charging station 110. In the illustrated embodiments, the clips 250 are made of a metallic material such that they be magnetically attracted by the magnet assemblies 206. The clips 250 provide another different mounting interface.

As illustrated in FIG. 8, a first clip 254 includes a plurality of flanges, arms, or tabs including a contact portion or rim mount 254a, a cleat contact portion 254b, and magnet contact portion 254c. The rim mount 254a is sized and shaped to wrap around or rest over the rim 228. Another end of the fist clip 254 (e.g., the cleat contact portion 254b) is received under the lips 198 of one or more cleat 194. The magnet contact portion 254c extends from one or more of the rim mount 254a and the cleat contact portion 254b and is attracted to the magnet assemblies 206. In particular, the first clip 254 is attracted to an upper magnet assembly 206a.

As also shown in FIG. 8, the rim 228 is attracted to a lower magnet assembly 206b. Thus, the first clip 254 is received by the lips 198 and attracted to the magnet assembly 206, and the rim 228 is received by the first clip 254 and the attracted to the magnet assembly 206. In the illustrated embodiment, the first clip 254 is sized and shaped to fit with normal or typically dimensioned rims 228. In other embodiments, the first clip 254 may be sized and shaped to fit with a variety of differently sized rims 228, walls, structures, gang boxes, and/or the like. As best illustrated in FIG. 10, the clips 250 have a width that engages two or less of the cleats 194/lips 198, and a plurality of clips 250 are provided for mounting the charging station 110. In other embodiments, a single clip 250 may be provided that engages more than two, or even all, of the cleats 194/lips 198 simultaneously.

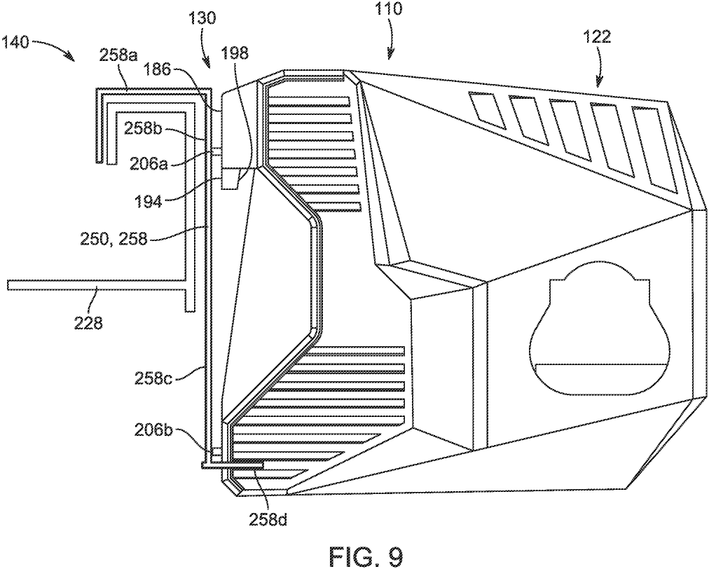

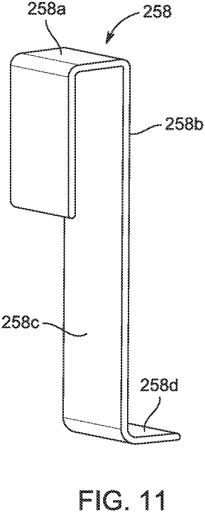

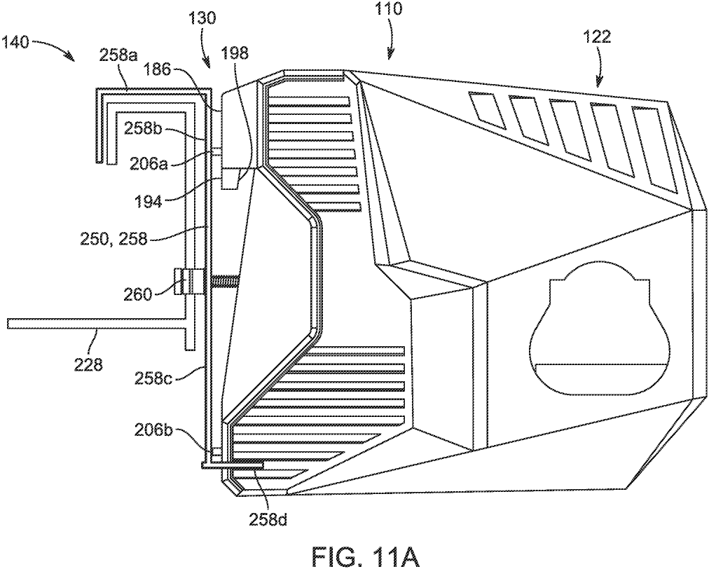

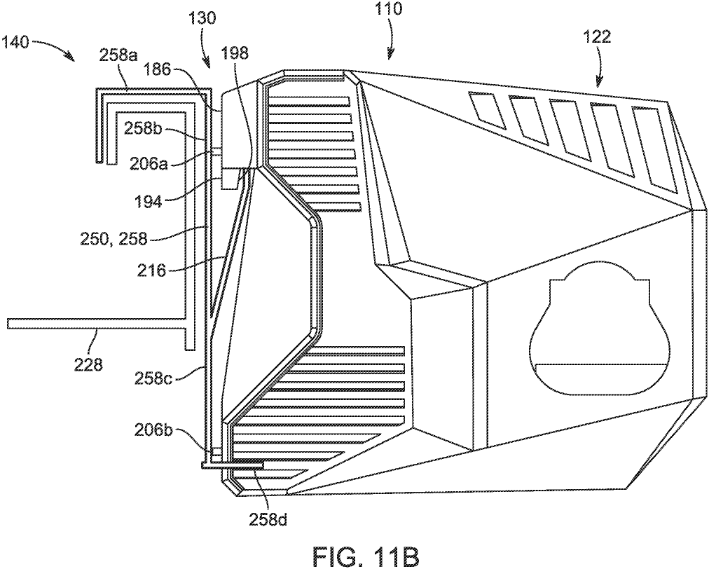

Referring now to FIGS. 9-11B, a second clip 258 includes a plurality of flanges, arms, or tabs including a rim mount or contact portion 258a, an upper magnet contact portion 258b, and a lower magnet contact portion 258c. As best illustrated in FIG. 11, the second clip 258 further includes a stab member 258d positioned at an end of the second clip 258. The rim mount 254a is sized and shaped to wrap around or rest over the rim 228, and the stab member 258d is configured to be inserted into a portion (e.g., housing 122) of the charging station 110 to provide still another different mounting interface. In one example embodiment, the stab member 258d may abut against a lower surface of the housing 122 to provide another different mounting interface, such that a bottom part of the charging station 110 may rest on the stab member 258d. In contrast to the first clip 254, the second clip 258 does not need to be received under the lips 198. Rather, the second clip 258 may be inserted into the housing 122 and attracted to both the upper and lower magnet assemblies 206a, 206b. In some embodiments, the stab member 258d may be removed such that the second clip 258 is attached to the charging station 110 solely through magnetic attraction.

As further illustrated in FIG. 10, another mount interface may be provided, with which the charging station 110 may be mounted to the shelf 14, and an extension 262 of the clip 250 may contact an upper surface of the shelf 14. In such embodiment of the mounting portion 130, the shelf 14 may be snap-fitted between the extension 262 and another portion (e.g., lower or opposing extension) of the clip 250. In some embodiments, the magnetic force on the clips 250 from the magnet assembly 206 (not shown) also attracts the rim 228/shelf 14 to the charging station 110. For example, as shown in FIG. 9, the upper magnet assembly 206a attracts the rim 228/shelf 14 to the clip 258 and attracts the clip 258 to the charging station 110.

Similar to the first clip 254, the second clip 258 is sized and shaped to fit with normal or typically dimensioned rims 228 and shelves 14. In some embodiments, the second clip 258 may be sized and shaped to fit with a variety of differently sized rims 228, walls, structures, gang boxes, shelves 14, and/or the like. Additionally, the charging assembly 110 may include a variety of clips 250, such as the first clip 254 and the second clip 258. A user may retain one or more of each clip 254, 258 for alternate/selective use based on a desired application (e.g., size, shape, width, etc.) of mounting surface.

As illustrated in FIGS. 11A and 11B, the clips 254, 258 may include one or more additional mounting or retention members that interface with the charging station 110 to further secure the clips 254, 258 to the mounting portion 130. With reference to FIG. 11A, a fastener 260 can be threaded through the second clip 258 and into the mounting portion 130 to provide another different mount interface. In some embodiments, the fastener 260 includes a captive thumb screw that can be screwed into the through-hole 216 to attach the second clip 258 to the charging station 110. With reference to FIG. 11B, a flange 261, such as a retention flange, extends from the second clip 258 and into the lip 198 formed by the cleats 194. In some embodiments, the flange 261 is integrally formed with the second clip 258 and fits into the lip 198 to provide additional retention for attached the second clip 258 to the charging station 110. In some embodiments, the second clip 258 and/or flange 261 is partially flexible such that a portion of the second clip 258 is deformed to more securely fit the flange 261 within the lip. In some embodiments, the clips 254, 258 and the flange 261 are formed of sheet metal or a similar material.

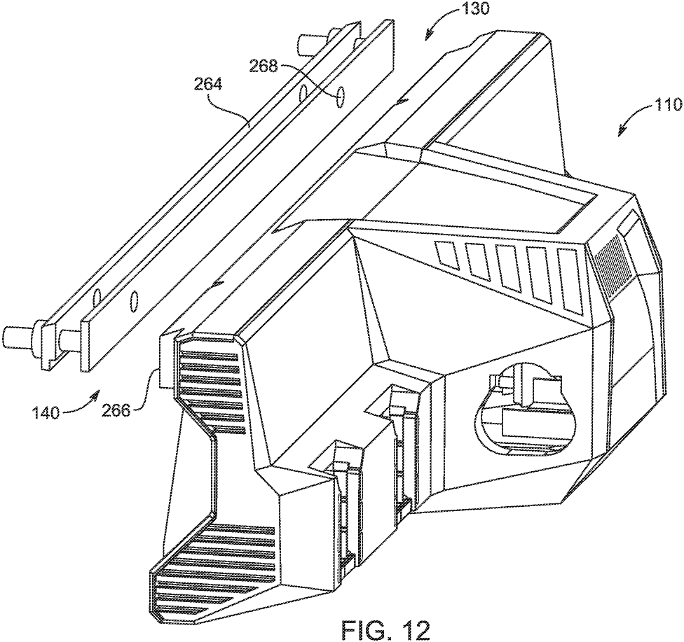

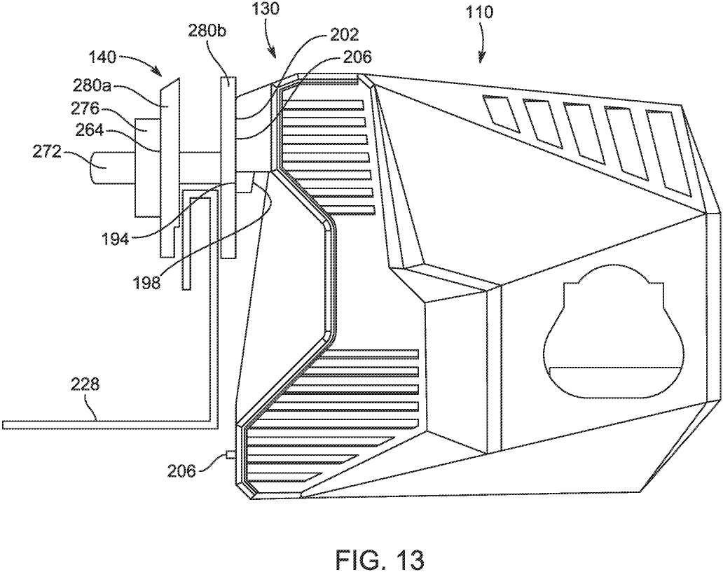

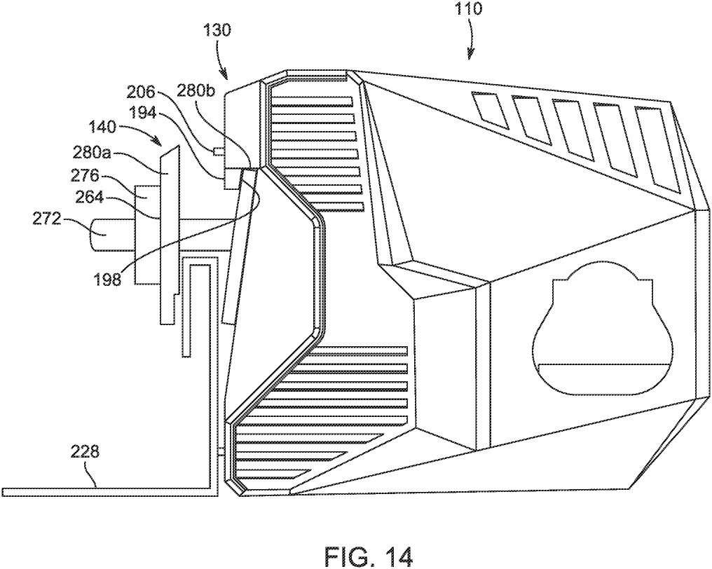

In some further embodiments of the mounting portion 130, as illustrated in FIGS. 12-14, the mount assembly 140 of the charging station 110 may further or alternatively include a detachable bracket, such as a detachable cleat 264. As illustrated in FIG. 12, the detachable cleat 264 can be mounted to a flat rear surface 266 of the charging station 110 such that the integral cleats 194 may be omitted from the mounting portion 130. Removal of the integral cleats 194 may provide the charging station 110 with a thinner overall footprint (e.g., depth, thickness, etc.) that provides another mount interface. As illustrated in FIGS. 13 and 14, the detachable cleat 264 can be coupled to the charging station 110 in addition to the integral cleats 194.

With continued reference to FIGS. 12-14, the detachable cleat 264 may be coupled to the charging station 110 via any of the mounting features of the mount assembly 140 or mounting portion 130. For example, the detachable cleat 264 may be attached to the charging station 110 through use of the keyed mounting apertures 202 and/or mounting through-holes 216. In such examples, the detachable cleat 264 includes one or like mounting holes 268 that commonly receive fasteners between the detachable cleat 264 and the charging station 110.

In another example, as illustrated best in FIG. 13, the detachable cleat 264 may be attached to the charging station 110 through use of the magnet assembly 206. The detachable cleat 264 could also be attached to the charging station 110 via the keyed mounting apertures 202 or mounting through-holes 216. That is, the keyed mounting apertures 202 and mounting through-holes 216 can be utilized even for a mounting portion 130 that includes the integral cleats 194. In yet another example, as illustrated best in FIG. 14, the detachable cleat 264 may be received by one or more lips 198 of the integral cleats 194.

In each embodiment/example, the detachable cleat 264 may receive the rim 228 or shelf 14. The illustrated detachable cleat 264 includes a bolt 272, such as a though-bolt, supporting an knob 276, such as an adjusting knob, and two opposing support plates 280a, 280b. In some embodiments, the bolt 272 is threaded, and the knob 276 is rotatable to adjust a distance between the support plates 280a, 280b. In operation, a user may rotate the knob 276 relative the bolt 272 to position the support plates 280a, 280b on either sides of the rim 228/shelf 14. In other embodiments, the support plates 280a, 280b may be biased toward one another by a biasing member, such as a spring. The detachable cleat 264 may be adjustable to a wide variety of thicknesses and/or depths in order to accommodate mounting of the charging station 110 to a similarly wide variety of rims 228, shelves 14, structures, and/or the like.

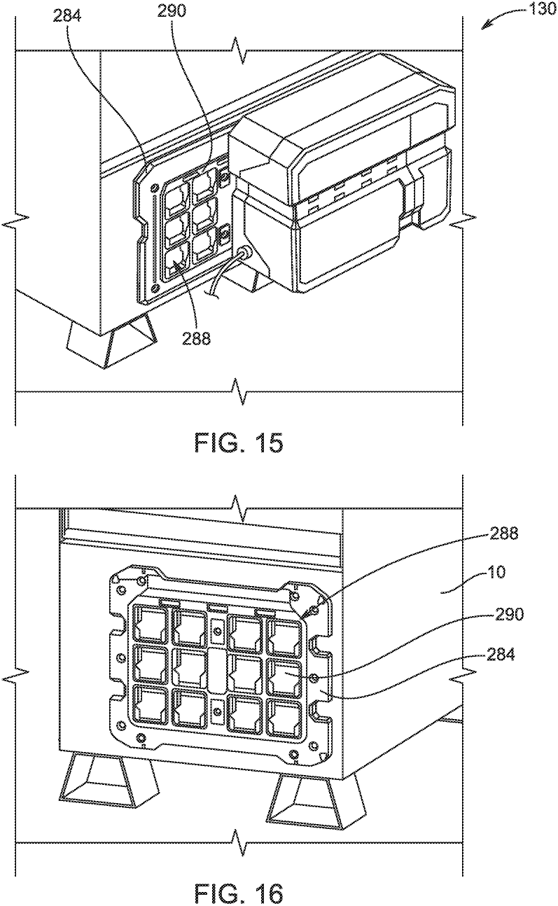

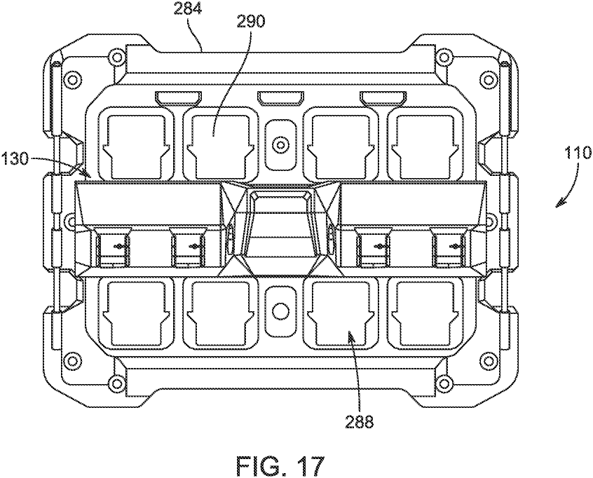

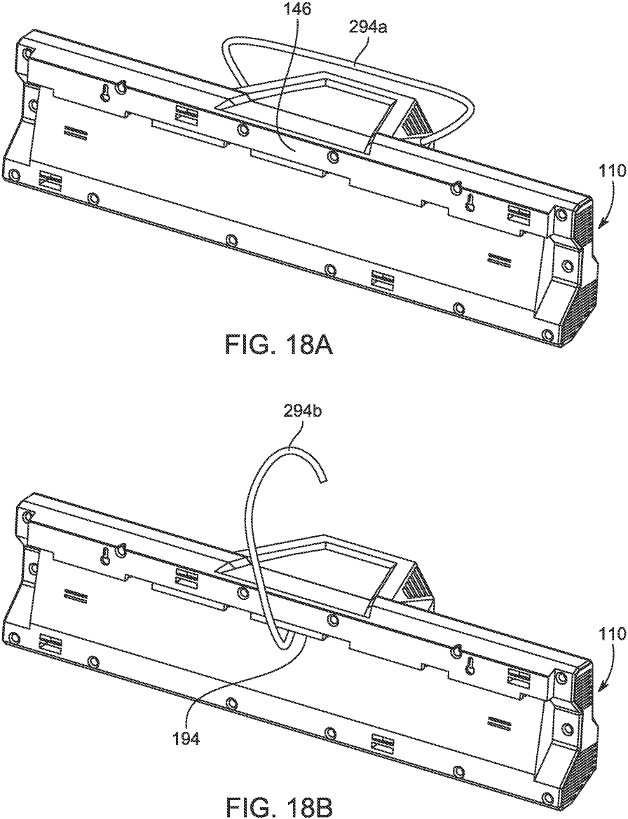

In other further embodiments of the mounting portion 130, as illustrated in FIGS. 15-17, the mount assembly 140 of the charging station 110 may further or alternatively include an mating/mounting interface compatible with the modular PACKOUT™ mating interface, commercialized by Milwaukee Electric Tool Corporation. Aspects of said modular mating interface are described and illustrated in pending U.S. Pat. Application No. 17/480,651, filed Sep. 21, 2021, the entire content of which is incorporated herein by reference. As illustrated in FIG. 15, said modular mating interface is provided on a panel 284 that may be coupled (e.g., fastened, attached, etc.) to a wall or to the gang box 10. The panel 284 includes a grid of recesses 288 each having a receiving pocket 290. The mounting portion 130 of the charging station 110 may be provided with complementary cleats that interface with the receiving pockets 290 to mate the charging station with the panel 284.

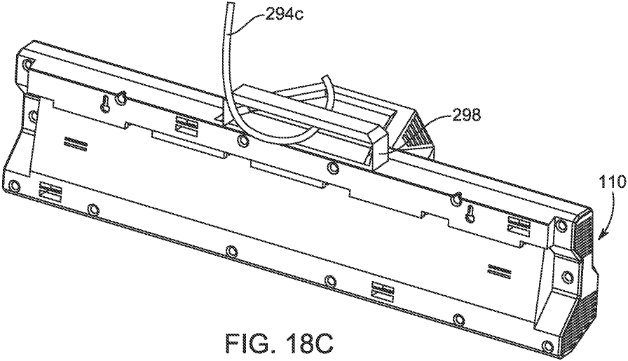

In some embodiments, as illustrated in FIGS. 18A-18C, the charging station 110 may include one or more additional connectors, such as hooks, straps, chains, and/or the like. FIG. 18A illustrates a connector 294a, such as a hook-type connector, attached to opposing sides of the electronics hub 146. FIG. 18B illustrates a similar (e.g., hook-type) connector 294b attached under the cleats 194. FIG. 18C illustrates another hook-type connector (e.g., connector 294c) attached under an optional top handle 298 of the charging station 110. The connectors 294a, 294b, 294c may be utilized for mounting the charging station 110 to the rims 228 or shelves 14 and/or assist with attaching the charging station 110 to the gang box 10 or other structure.

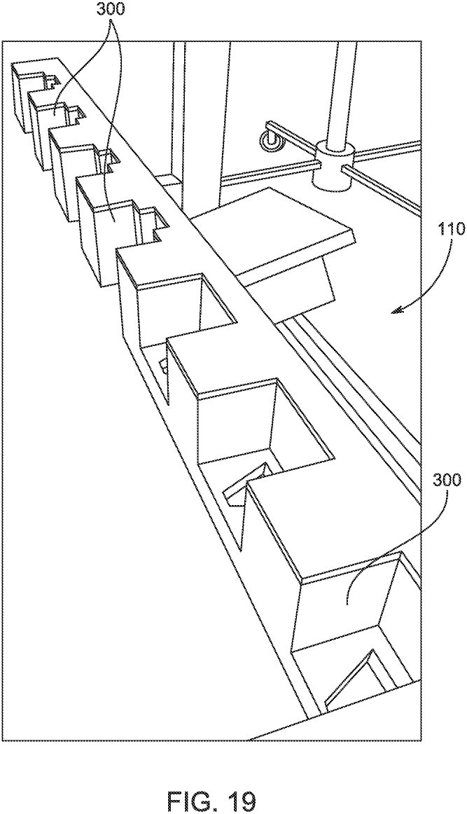

With brief reference to FIG. 19, the charging station 110 may includes a multi-bay charging port assembly 300. The multi-bay charging port assembly 300 may be an extension of the charging station 110 or an independent charging device. The multi-bay charging port assembly 300 may be compatible with each of the mounting solutions described with reference to the charging station 110. The multi-bay charging port assembly 300 may further include a cradle configured to receive several smaller battery charging ports.

Although aspects of the disclosure have been described in detail with reference to certain preferred constructions, variations and modifications exist within the scope and spirit of one or more independent aspects of the disclosure as described. For example, the charging station 110 may be equipped with some, one, or all of the mounting solutions discussed herein. It should be understood that such mounting solutions may be provided by the various different mount interfaces. Various features and advantages of the disclosure are set forth in the following claims.

What is claimed is:

1. A charging station removably mountable on a structure, the charging station comprising:
a housing defining a first side and a second side opposite the first side;
a plurality of charging ports disposed on the first side, each of the plurality of charging ports including a battery receptacle configured to receive and charge a battery pack; and
a mount assembly disposed on the second side and engageable with the structure to removably mount the charging station thereon, the mount assembly including a first mount interface and second mount interface, the second mount interface being different than the first mount interface.

2. The charging station of claim 1, wherein the plurality of charging ports includes
a first charging port including a first battery receptacle configured to receive and charge a battery pack of a first type, and
a second charging port including a second battery receptacle configured to receive and charge a battery pack of a second type different than the first type.

3. The charging station of claim 2, further comprising:
a hub configured to house electronics for controlling the charging station;
a first wing extending from the hub in a first direction; and
a second wing extending from the hub in a second direction opposite the first direction, wherein the first side is a forward side, and the second side is a rear side.

4. The charging station of claim 3, wherein the first charging port is positioned on the first wing, and wherein the second charging port is positioned on one or more of the second wing and the hub.

5. The charging station of claim 2, wherein the first battery receptacle includes a slot and a rail, and wherein the second battery receptacle includes a socket.

6. The charging station of claim 2, wherein the battery pack of the first type and the battery pack of the second type are insertable into the plurality of charging ports in different directions.

7. The charging station of claim 1, wherein the structure is a container including a lid and walls, and wherein the charging station is selectively removably mountable to one or more of the lid and the walls.

8. The charging station of claim 1, wherein the structure is a container defining a rim, and wherein the mount assembly defines a lip extending from the second side and engageable with the lip.

9. A charging station removably mountable on a structure including a container, the charging station comprising:
a charging portion;
a mounting portion;
a first charging port disposed on the charging portion, the first charging port including a first battery receptacle configured to receive and charge a battery pack of a first type;
a second charging port disposed on the charging portion, the second charging port including a second battery receptacle configured to receive and charge a battery pack of a second type different than the first type; and
a mount assembly coupled to the mounting portion and selectively couplable with the container.

10. The charging station of claim 9, wherein the mount assembly includes one or more hooks.

11. The charging station of claim 10, wherein the one or more hooks includes an adjustable cleat removably coupled to one or more of the charging station and the container.

12. The charging station of claim 9, wherein the mount assembly includes one or more adjustable clips integrally formed with the charging station.

13. The charging station of claim 12, wherein the adjustable clips are retractable into the mounting portion of the charging station.

14. The charging station of claim 9, wherein the mount assembly includes one or more clips magnetically coupled to the charging station.

15. The charging station of claim 9, wherein the mount portion includes a plurality of apertures each configured to receive a fastener secured to one or more of the mount assembly and the container.

16. The charging station of claim 15, wherein each aperture is keyed and configured to receive a head of the fastener.

17. The charging station of claim 9, wherein the mount portion includes a plurality of through-holes each configured to receive a fastener secured to one or more of the mount assembly and the container.

18. The charging station of claim 9, wherein the charging station as a length, and wherein the length of the charging station is approximately half a length of the container.

19. The charging station of claim 15, wherein the length of the charging station is less than a length of a side wall of the container.

20. A charging station comprising:
a hub configured to house electronics for controlling the charging station;
a first wing extending from the hub in a first direction;
a second wing extending from the hub in a second direction opposite the first direction;
a first charging port disposed on one or more of the first wing and the second wing, the first charging port including a first battery receptacle configured to receive and charge a battery pack of a first type;
a second charging port disposed on the hub, the second charging port including a second battery receptacle configured to receive and charge a battery pack of a second type different than the first type; and
a mount assembly coupled to one or more of the hub, the first wing, and the second wing,
wherein the mount assembly is configured to selectively mount the charging station on a structure.
